(19) United States
(12) Patent Application Publication
(10) Pub. No.: US 2016/0200212 A1
(43) Pub. Date: Jul. 14, 2016

(54) CUSTOMER SELECTABLE POWER LIMIT FOR ELECTRIC VEHICLES

(71) Applicant: GM Global Technology Operations LLC, Detroit, MI (US)

(72) Inventor: OLAF SIX, White Lake, MI (US)

(21) Appl. No.: 14/596,845

(22) Filed: Jan. 14, 2015

(51) Int. Cl. B60L 11/18; B60K 35/00; B60L 15/20

(52) U.S. Cl. CPC B60L 11/1862; B60L 15/2045; B60K 35/00; B60K 2350/1096

(57) ABSTRACT

A system and method for operating an electric motor in a vehicle are disclosed. A motor controller for controlling the supply of power to the electric motor may be provided. The system may include a manual input device that when engaged, may limit power supplied to the motor to a selected maximum.

### TECHNICAL FIELD

The field to which the disclosure generally relates includes electric vehicle drive systems and more particularly, to energy consumption in an electric vehicle drive system.

### BACKGROUND

Vehicles that operate on electrical energy provide an option to those that consume fuel in a combustion process. Generally, a storage device is provided that supplies the electric drive system with energy upon demand. The energy demand may come from the drive system and also from other vehicle systems that require power. The storage device inherently has a limited capacity and therefore, the ability to operate solely on electrical power is limited. This limitation restricts the distance the vehicle can travel to a range, before the storage device must be recharged or supplemented with an ancillary power system. The amount of time required to recharge the storage device is generally long enough to cause the driver to preplan, to ensure the vehicle is at a suitable charging location. As a result, range is a significant factor in operating an electric vehicle.

An electric vehicle's range can vary based on a number of factors. These may include the driving habits of the vehicle's operator, ambient and road conditions, the demand from vehicle systems other than the drive unit, the condition of the storage device, the manner in which the drive system is calibrated and programmed, and other factors. Other than driving habits and comfort setting changes, the factors that affect range are generally beyond the control of the vehicle's operator.

### SUMMARY OF ILLUSTRATIVE VARIATIONS

A number of variations may include a system for a vehicle operating on electricity. An electric motor may be provided and a motor control module may control the supply of current to the electric motor. A manual input device may be provided that when engaged, limits current supplied to the motor by the motor controller to a selected maximum. The selected maximum may be a variable chosen to conserve stored energy in the energy storage device.

Other variations may include a system to extend the range of an electric vehicle. A motor may be provided that operates at system voltage. A motor controller may control the supply of electric power to the motor by varying current at the system voltage. A power limit selector may be provided through which a maximum power limit may be manually selected for supply to the motor. During operation of the electric vehicle, the motor controller may limit the supply of power to the motor, by limiting the current to a maximum current reflective of the selected maximum power.

Still other variations may include a method of controlling an electric motor in a vehicle. A driver interface may be provided through which a limit on electric power supplied to the electric motor may be selected. Electric power supplied to the electric motor may be limited to the selected limit during operation of the vehicle.

Other illustrative variations within the scope of the invention will become apparent from the detailed description provided herein. It should be understood that the detailed description and specific examples, while disclosing variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 is a simplified block diagram of a customer selectable power limit for electric vehicles according to a number of variations.

FIG. 2 is a schematic illustration of part a vehicle's instrument panel according to a number of variations.

### DETAILED DESCRIPTION OF ILLUSTRATIVE VARIATIONS

The following description of the variations is merely illustrative in nature and is in no way intended to limit the scope of the invention, its application, or uses.

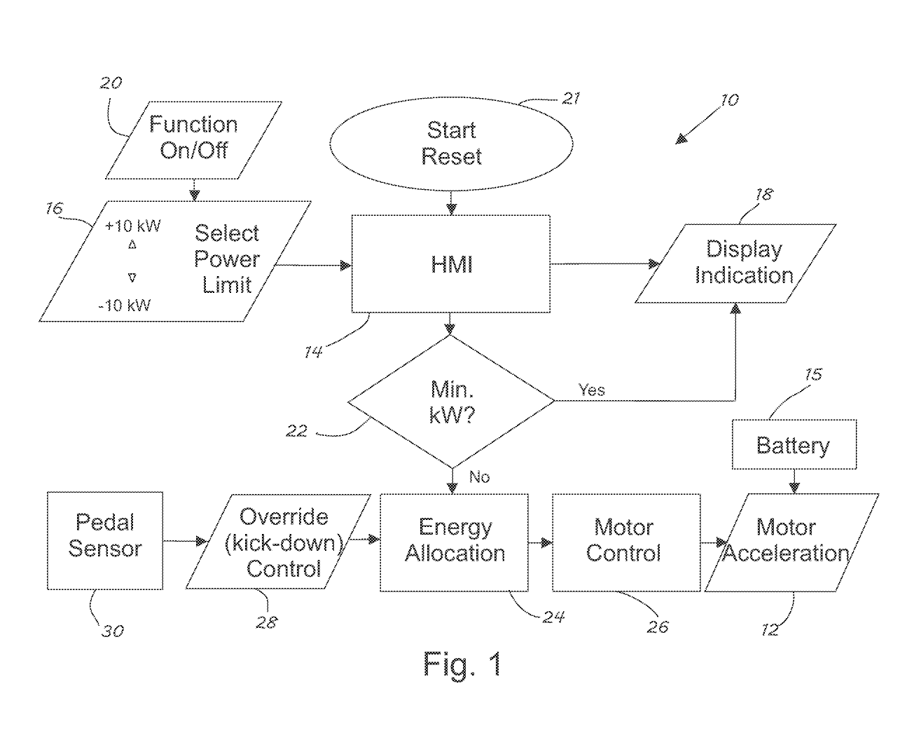

In a vehicle that is propelled or supplemented by one or more electric motors, power consumed is related to the current and voltage supplied to the motor. The power may be measured in kilowatts and as it is consumed, discharges the vehicle's energy storage device. Power consumption progressively reduces the vehicle's remaining range. To reduce the rate at which the power is consumed, a number of variations may include a customer selectable power limiter 10 as shown in FIG. 1. The power limiter 10 may be used to limit power consumed at the motor 12, which may operate at a selected system voltage. Power may be limited by managing the current supplied from the energy storage device 15. In the power limiter 10, a human-machine interface (HMI), module 14 may operate as an interface with the vehicle's operator, with a power limit selector 16 and a display indicator 18.

The power limit selector 16 may be in a control panel accessible to the driver and may enable the selection of the maximum power limit to be supplied to the motor 12. The options for maximum power selection may be variable and may have graduations in single or multiple units and may be identified in power, or power related units. As shown in FIG. 1, the power limit selector 16 allows for the selection of a power limit by the driver in steps of ten kilowatts. The options made available to the driver for power restriction may be limited to a lower threshold above which vehicle operation is suitable, and an upper limit at or near the upper design limit for discharging power from the energy storage device 15. For example, this range may include a lower threshold of 30 kilowatts and may include an upper threshold of 120 kilowatts.

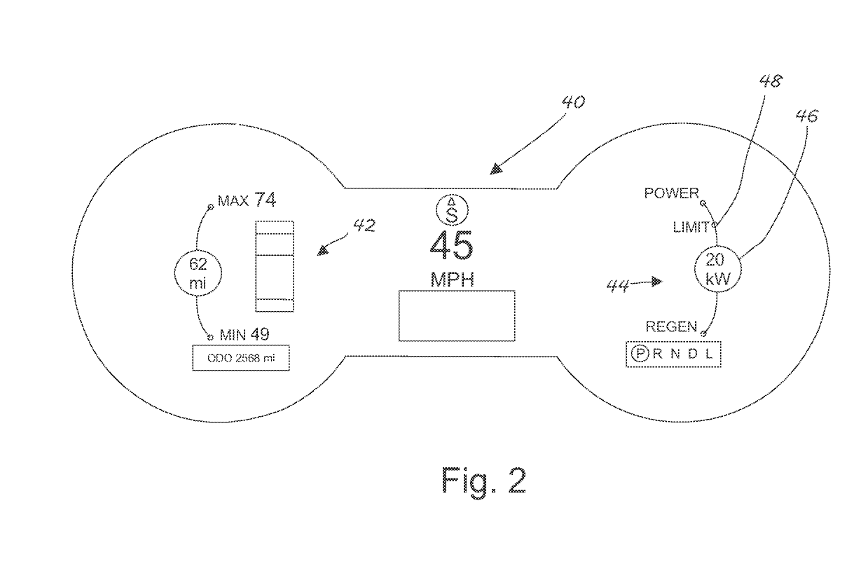

A display indicator 18 may be located in the vehicle's instrument panel for presentation to the driver along with other vehicle related information. Referring additionally to FIG. 2, the instrument panel 40 may include an indicator 42 that displays the remaining charge in the energy storage device 15, and may include an estimation of the vehicle's remaining range. The display may also indicate an estimated maximum and minimum range depending on varying conditions. As shown in the example illustrated, the remaining estimated range is 62 miles, with an estimated minimum of 49 miles and an estimated maximum of 74 miles. The instrument panel may also include a power indicator 44 that may include a ball display 46 that indicates the current state of power use. Bars may move up and down depending on power consumption or regeneration status. The power indicator 44 may also include a power limit indication 48 that may illuminate at the corresponding location when the driver selects a maximum power limit through the power limit selector 16. When the bars out of ball display 46 reach the selected limit 48, an indication may be provided to the driver through a color change or other display mechanism, to alert the driver that the power demand is being limited.

As shown in FIG. 1, the power limiter 10 may include a control element 20 to activate and disable the power limiting function. The control element 20 may be programmed to disable the power limiting function if predetermined driving conditions exist, which dictate providing power in excess of the selected limit. When activated, the vehicle's driver may engage the power limiter function by selecting a limit at the power limit selector 16, which is communicated to the HMI module 14, and indicated at the display indicator 18. The power limiter routine may start and be reset at the block 21, and may proceed to the HMI module 14. The power limiter 10 may include a block 22 where a determination is made as to whether the driver has selected a power value below the minimum threshold. If a determination is made that the selected value is below the minimum threshold, then an indication may be provided to the driver through the display indicator 18 and the power limiter stays at the lower limit threshold. If a determination is made that the selected value is not below the minimum threshold, then the power limiter 10 may be engaged and the selected limit is communicated to the energy allocation module 24.

The energy allocation module 24 may provide a function of allocating power from the energy storage device 15 to various loads such as a motor 12, and devices such as a heater and an air conditioner. For power allocated to the motor 12, the energy allocation module 24 communicates with the motor control module 26, which controls the supply of power to the motor 12 by varying current supply. With a maximum power limit selected at the power limit selector 16, the motor control module 26 controls the supply of power to the motor 12 as demanded by the driver, and operates the vehicle up to the set maximum power limit as allocated by the energy allocation module 24. The energy allocation module 24 may be programmed to separately limit the current supplied to the electric motor 12 based on a state of charge of the energy storage device 15. For example, if the state of charge is low, the supplied current may be limited.

Should driving conditions dictate that the set maximum power limit has to be exceeded, a control element linked to the vehicle's accelerator actuator may be provided. An override control module 28 may receive input from an accelerator pedal sensor 30, which may indicate the extent to which the accelerator is actuated. In situations where the driver calls for a high level of power as reflected by the extent of pedal depression, the override control module 28 may communicate the desire to override the selected power limit and allocate additional power to the motor 12. For example, a pedal depression amount exceeding a certain percent of travel, such as eighty percent, may dictate overriding the selected power limit. In such a case, an amount of power directly reflecting the demand based on pedal input, may be supplied to the motor 12 even though it exceeds the selected power limit.

The following description of variants is only illustrative of components, elements, acts, products and methods considered to be within the scope of the invention and is not in any way intended to limit such scope by what is specifically disclosed or not expressly set forth. Components, elements, acts, products and methods may be combined and rearranged other than as expressly described herein and still are considered to be within the scope of the invention.

Variation 1 may include a system for a vehicle operating on electricity. An electric motor may be provided and a motor control module may control the supply of current to the electric motor. A manual input device may be provided that when engaged, limits current supplied to the motor by the motor control module to a selected maximum. The selected maximum may be a variable chosen to conserve stored energy in the energy storage device.

Variation 2 may include a system according to variation 1 and may include a control element linked to an accelerator pedal of the vehicle, wherein the selected maximum is engaged independent of the accelerator pedal and is overridden when the accelerator pedal is depressed beyond a predetermined threshold.

Variation 3 may include a system according to variation 2 wherein the threshold is set at approximately eighty percent of pedal travel.

Variation 4 may include a system according to any of variations 1 through 3 and may include a driver interface with an indicator that displays the selected maximum.

Variation 5 may include a system according to variation 4 wherein the selected maximum is displayed in kilowatts.

Variation 6 may include a system according to any of variations 1 through 5 and may include an energy storage device. An energy allocation element may be provided that separately limits the current supplied to the electric motor based on a state of charge of the energy storage device.

Variation 7 may include a system according to any of variations 1 through 6 wherein the selected maximum is reset to 100 percent when the vehicle is powered off.

Variation 8 may include a system according to any of variations 1 through 7 wherein the selected maximum that may be selected is 30 kilowatts or higher.

Variation 9 may include a system according to any of variations 1 through 8 and may include an energy storage device. The selected maximum may be independent of a state of charge of the energy storage device.

Variation 10 may include a system according to any of variations 1 through 9 wherein the selected maximum may be selected in 10 kilowatt increments.

Variation 11 may include a system to extend the range of an electric vehicle. A motor may be provided that operates at system voltage. A motor controller may control the supply of electric power to the motor by varying current at the system voltage. A power limit selector may be provided through which a maximum power limit may be manually selected for supply to the motor. During operation of the electric vehicle, the motor controller may limit the supply of power to the motor, by limiting the current to a maximum current reflective of the selected maximum power.

Variation 12 may include a system according to variation 11 and may include a control element linked to an accelerator pedal of the vehicle. The control element may override the selected maximum power when the accelerator pedal is depressed beyond a threshold.

Variation 13 may include a system according to variation 12 wherein the threshold is set at approximately eighty percent of pedal travel.

Variation 14 may include a system according to any of variations 11 through 13 and may include a driver interface with an indicator that displays the selected maximum.

Variation 15 may include a system according to any of variations 11 through 14 and may include an energy storage device. An energy allocation element may be provided that independently limits the current supplied to the electric motor based on a state of charge of the energy storage device.

Variation 16 may include a system according to any of variations 11 through 15 wherein the selected maximum is reset to 100 percent when the vehicle is powered off.

Variation 17 may include a system according to any of variations 11 through 16 and may include an energy storage device. The selected maximum may be independent of a state of charge of the energy storage device.

Variation 18 may include a method of controlling an electric motor in a vehicle. A driver interface may be provided through which a limit on electric power supplied to the electric motor may be selected. Electric power supplied to the electric motor may be limited to the selected limit during operation of the vehicle.

Variation 19 may include a method according to variation 18 and may include the step of overriding the selected limit and supplying additional power when an accelerator of the vehicle is actuated beyond a threshold.

Variation 20 may include a method according to variation 18 or 19 and may include the step of automatically resetting the selected maximum to 100 percent when the vehicle is powered off.

The above description of select variations within the scope of the invention is merely illustrative in nature and, thus, variations or variants thereof are not to be regarded as a departure from the spirit and scope of the invention.

What is claimed is:

1. A system for a vehicle operating on electricity comprising: an electric motor; a motor control module controlling the supply of current to the electric motor from an energy storage device; and a manual input device that when engaged, limits current supplied to the motor by the motor control module to a selected maximum, wherein the selected maximum is a variable chosen to conserve stored energy in the energy storage device.

2. The system according to claim 1 further comprising a control element linked to an accelerator pedal of the vehicle, wherein the selected maximum is engaged independent of the accelerator pedal and is overridden when the accelerator pedal is depressed beyond a predetermined threshold.

3. The system according to claim 2 wherein the predetermined threshold is set at approximately eighty percent of pedal travel.

4. The system according to claim 1 further comprising a driver interface with an indicator that displays the selected maximum.

5. The system according to claim 4 wherein the selected maximum is displayed in kilowatts.

6. The system according to claim 1 further comprising an energy storage device; and an energy allocation element that separately limits the current supplied to the electric motor based on a state of charge of the energy storage device.

7. The system according to claim 1, wherein the selected maximum is reset to 100 percent when the vehicle is powered off.

8. The system according to claim 1 wherein the selected maximum is selectable at 30 kilowatts or higher.

9. The system according to claim 1 further comprising an energy storage device; wherein the selected maximum is independent of a state of charge of the energy storage device.

10. The system according to claim 1 wherein the selected maximum may be selected in 10 kilowatt increments.

11. A system to extend the range of an electric vehicle comprising: a motor operating at a system voltage; a motor controller, controlling a supply of electric power to the motor by varying current at the system voltage; a power limit selector through which a maximum power is manually selected for supply to the motor; wherein during operation of the electric vehicle, the motor controller limits the supply of power to the motor by limiting the current to a maximum current reflective of the selected maximum power.

12. The system according to claim 11 further comprising a control element linked to an accelerator pedal of the vehicle that overrides the selected maximum power when the accelerator pedal is depressed beyond a threshold.

13. The system according to claim 11 wherein the threshold is set at approximately eighty percent of pedal travel.

14. The system according to claim 11 further comprising a driver interface with an indicator that displays the selected maximum.

15. The system according to claim 11 further comprising an energy storage device; and an energy allocation element that independently limits the current supplied to the electric motor based on a state of charge of the energy storage device.

16. The system according to claim 11, wherein the selected maximum is reset to 100 percent when the vehicle is powered off.

17. The system according to claim 11 further comprising an energy storage device; wherein the selected maximum is independent of a state of charge of the energy storage device.

18. A method of controlling an electric motor in a vehicle comprising the steps of: a. providing a driver interface; b. through the driver interface, manually selecting a limit of electric power supplied to the electric motor; and c. limiting electric power supplied to the electric motor to the selected limit during operation of the vehicle.

19. The method according to claim 18 including the step of overriding the selected limit and supplying additional power when an accelerator of the vehicle is actuated beyond a threshold.

20. The method according to claim 18 including the step of automatically resetting the selected maximum to 100 percent when the vehicle is powered off.
